(19) United States
(12) Patent Application Publication
(10) Pub. No.: US 2026/0142379 A1
(43) Pub. Date: May 21, 2026

(54) RADIATOR MODULE AND ANTENNA DEVICE FOR PERFORMING BROADSIDE RADIATION AND END-FIRE RADIATION

(71) Applicant: POSTECH RESEARCH AND BUSINESS DEVELOPMENT FOUNDATION, Pohang-si (KR)

(72) Inventors: Won Bin HONG, Seoul (KR); Bum Hyun KIM, Pohang-si (KR)

(73) Assignee: POSTECH RESEARCH AND BUSINESS DEVELOPMENT FOUNDATION, Pohang-si (KR)

(21) Appl. No.: 19/122,228

(22) PCT Filed: May 9, 2023
(86) PCT No.: PCT/KR2023/006278

§ 371 Date: Apr. 17, 2025

(30) Foreign Application Priority Data
Dec. 8, 2022 (KR) 10-2022-0170284

(51) Int. Cl. H01Q 13/18; H01Q 21/00

(52) U.S. Cl. CPC H01Q 13/18; H01Q 21/0025

(57) ABSTRACT

Provided is a radiator module for performing broadside radiation and end-fire radiation. The radiator module includes: a cavity having a front open surface and an upper slot defined in an upper surface thereof; a widthwise feed line disposed under the upper slot and extending in a left-right direction of the cavity; and a vertical probe extending in a vertical direction and disposed inside the cavity.

### TECHNICAL FIELD

The present disclosure relates to wireless communication, and more particularly, to a radiator module and an antenna device for performing broadside radiation and end-fire radiation.

### DESCRIPTION OF RELATED ART

Wireless communication technology for transmitting and receiving information is continuously developing. In this regard, an antenna device is required to transmit or receive a signal for wireless communication, and various forms and schemes of antenna devices have been developed to achieve higher performance. Recently, a technology, such as a MIMO antenna, for overcoming performance limitation in that it is difficult to achieve the performance with a single antenna has been developed. A beam forming technology for controlling a radiation direction of a signal in order to maximize a strength of a transmission/reception signal between a base station and a terminal has been developed.

In particular, a recent wireless communication technology such as 3GPP 5G, for example, has started to use a frequency of a millimeter wave (mmWave) band. A beamforming technology using a phased array antenna has been more importantly applied in order to solve the problem in that the millimeter wave band wireless channel environment has free space path loss and diffraction reduction, and thus signal attenuation may occur. Such a beamforming technology is required in both the base station and the terminal, and in particular, is essential to secure wide coverage and overcome radio wave loss in a mobile radio channel environment.

However, since the phased array antenna for beamforming includes a plurality of radiators, an efficient mounting scheme thereof on a wireless terminal should be considered. For example, an antenna-in-package (AiP) technology in which an antenna and an RFIC are combined with each other is attracting attention as a solution for mounting the phased array antenna on the terminal. In order to minimize a shaded area and improve the beamforming coverage, a plurality of AiPs are required to be disposed in the terminal. In this case, a problem in that the mounting space becomes narrow may occur in consideration of electric coexistence thereof with other existing antennas and/or coexistence thereof with mechanical components.

### DETAILED DESCRIPTION

### Technical Problem

One purpose of the present disclosure to solve the above-described problems is to provide a radiator module in which a radiator performing broadside radiation and a radiator performing end-fire radiation are positioned in a spatially-superposing manner, thereby minimizing structural complexity and achieving a miniaturized structure, thereby maximizing space efficiency and improving beamforming coverage.

Another purpose of the present disclosure to solve the above-described problems is to provide an antenna device including a plurality of radiator modules, each radiator module being composed of a radiator performing broadside radiation and a radiator performing end-fire radiation positioned in a spatially-superposing manner, such that the antenna device is capable of individually performing beamforming in a broadside direction and beamforming in an end-fire direction.

However, the purposes to be achieved by the present disclosure is not limited thereto, and may be variously extended within a range not departing from the spirit and field of the present disclosure.

### Technical Solution

A radiator module for performing broadside radiation and end-fire radiation according to one embodiment of the present disclosure to achieve the above-described purpose may include: a cavity having a front open surface and an upper slot defined in an upper surface thereof; a widthwise feed line disposed under the upper slot and extending in a left-right direction of the cavity; and a vertical probe extending in a vertical direction and disposed inside the cavity.

According to one aspect, the vertical probe may receive electrical power from a first port via a first feed line, wherein the widthwise feed line may receive electrical power from a second port via a second feed line.

According to one aspect, the widthwise feed line may be electrically connected to the upper slot to perform broadside radiation.

According to one aspect, the vertical probe may be configured to perform the end-fire radiation through the front open surface.

According to one aspect, the cavity may be divided into an upper space and a lower space around a division surface, wherein the radiator module may be configured to perform the broadside radiation using the upper space, and perform the end-fire radiation using both the upper space and the lower space.

According to one aspect, the dividing surface may have a through hole defined therein through which the vertical probe passes.

According to one aspect, the radiator module may further include a metal layer pair, wherein the metal layer pair may include: an upper metal layer disposed in front of the upper surface of the cavity; and a lower metal layer disposed in front of a lower surface of the cavity and extending in parallel with the upper metal layer.

According to one aspect, impedance matching between the radiator module and a free space may be performed based on a spacing between the metal layer pair and the cavity and a length in a front-rear direction of the metal layer pair.

According to one aspect, a series capacitance component may be induced based on a spacing between the metal layer pair and the cavity, wherein an inductance component may be induced based on the length in the front-rear direction of the metal layer pair.

According to one aspect, the upper slot may include: a widthwise upper slot extending in the left-right direction of the cavity; and a lengthwise upper slot extending in a front-rear direction of the cavity.

According to one aspect, the radiator module may further include a widthwise lower slot defined in a lower surface of the cavity and extending in parallel with the widthwise upper slot, such that the widthwise upper and lower slots constitute a slot pair.

According to one aspect, a spacing between the slot pair and the open surface may be π/4.

According to one aspect, an electric field generated from the widthwise upper slot and an electric field generated from the widthwise lower slot may have the same magnitude and different phases opposite to each other and, thus, may offset each other.

According to one aspect, the radiator module operates as a cavity backed slot antenna performing the broadside radiation based on the lengthwise upper slot.

According to one aspect, impedance matching may be performed based on a width of the lengthwise upper slot, wherein a frequency band may be determined based on a length of the lengthwise upper slot.

According to one aspect, the lengthwise upper slot may have a length of π/2, wherein the widthwise upper slot may have a length of π, and wherein the lengthwise upper slot and the widthwise upper slot may be configured to be in contact with each other at a midpoint of the widthwise upper slot.

According to one aspect, the vertical probe may be disposed in front of the widthwise upper slot.

An antenna device for performing broadside radiation and end-fire radiation according to another embodiment of the present disclosure to achieve the above-described purpose may include a radiator array including a plurality of radiator modules; and a control circuit configured to apply a signal to the plurality of radiator modules, wherein each of the plurality of radiator modules may include: a cavity having a front open surface and an upper slot defined in an upper surface thereof; a widthwise feed line disposed under the upper slot and extending in a left-right direction of the cavity; and a vertical probe extending in a vertical direction and disposed inside the cavity.

According to one aspect, the control circuit may be configured to control each of the plurality of radiator modules to perform broadside radiation to perform broadside directional beamforming.

According to one aspect, the control circuit may be configured to control each of the plurality of radiator modules to perform end-fire radiation to perform end-fire directional beamforming.

### Technical Effects

The disclosed technology may have the following effects. However, since it does not mean that the specific embodiment should include all of the following effects or only the following effects, it should not be understood that the scope of the rights of the disclosed technology is limited thereto.

According to the above-described radiator module for performing broadside radiation and end-fire radiation according to an embodiment of the present disclosure, the radiator for performing broadside radiation and the radiator for performing end-fire radiation are positioned in a spatially-superposing manner, thereby minimizing structural complexity and achieving a miniaturized structure, thereby maximizing spatial efficiency and improving beamforming coverage.

In addition, according to the antenna device for performing broadside radiation and end-fire radiation according to another embodiment of the present disclosure described above, the antenna device includes the plurality of radiator modules, each radiator module being composed of a radiator for performing broadside radiation and a radiator for performing end-fire radiation positioned in a spatially-superposing manner, such that the antenna device can individually perform beamforming in a broadside direction and beamforming in an end-fire direction.

### BRIEF DESCRIPTION OF THE DRAWINGS

FIG. 1 is a perspective view of a radiator module for performing broadside radiation and end-fire radiation according to an embodiment of the present disclosure.

FIG. 2 illustrates a broadside radiation part of the radiator module of FIG. 1.

FIG. 3 illustrates an end-fire radiation part of the radiator module of FIG. 1.

FIG. 4 is an example diagram of a radiator module implemented through a stacking scheme.

FIG. 5 illustrates an example numerical design of the radiator module of FIG. 4.

FIG. 6 is a side view of an example radiator module implemented through a stacking scheme.

FIG. 7 illustrates a metal layer pair of a radiator module according to one aspect.

FIG. 8 illustrates impedance matching based on a spacing between the metal layer pair of FIG. 7 and a cavity.

FIG. 9 illustrates impedance matching based on a length of the metal layer pair of FIG. 7.

FIG. 10 is an example diagram of improvement of a front-back ratio based on a distance between a slot pair and an open surface of a radiator module according to one aspect.

FIG. 11 illustrates an aspect of radiation according to the arrangement of FIG. 10.

FIG. 12 shows an example in which electric fields generated from upper and lower slots offset each other according to one aspect.

FIG. 13 illustrates a strong coupling phenomenon between a vertical probe and a widthwise upper slot.

FIG. 14 illustrates an example of improvement in coupling between ports according to arrangement of a widthwise slot and a lengthwise slot.

FIG. 15 is an example application diagram in which an antenna device according to an embodiment of the present disclosure is applied to a wireless terminal.

### EMBODIMENTS OF THE PRESENT DISCLOSURE

Since the present disclosure may be subjected to various changes and may have various embodiments, specific embodiments will be illustrated in the drawings and described in detail.

However, it should be understood that this is not intended to limit the present disclosure to the specific embodiments, and the present disclosure includes all changes, equivalents, and substitutes included in the spirit and technical scope of the present disclosure.

Terms such as first, second, and the like may be used to describe various components, but the components should not be limited by the terms. The terms are used only for the purpose of distinguishing one component from another component. For example, without departing from the scope of the present disclosure, a first component may be referred to as a second component, and similarly, a second component may also be referred to as a first component. The term and/or includes a combination of a plurality of related described items or any of a plurality of related described items.

When it is mentioned that one component is “connected” or “coupled” to another component, it should be understood that one component may be directly connected or coupled to another component, or still another component may be interposed therebetween. On the other hand, when it is mentioned that one component is “directly connected” or “directly coupled” to another component, it should be understood that still another component does not exist therebetween.

The terminology used herein is directed to the purpose of describing particular embodiments only and is not intended to be limiting of the present disclosure. As used herein, the singular constituents “a” and “an” are intended to include the plural constituents as well, unless the context clearly indicates otherwise. It will be further understood that the terms “comprise”, “comprising”, “include”, and “including”, when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, some embodiments of the present disclosure will be described in more detail with reference to the accompanying drawings. In the description of the present disclosure, in order to facilitate overall understanding, the same reference numerals are used for the same components in the drawings, and repeated descriptions of the same components are omitted.

As described above, since the phased array antenna for beamforming includes a plurality of radiators, an efficient mounting scheme thereof on a wireless terminal should be considered. For example, an antenna-in-package (AiP) technology in which an antenna and an RFIC are combined with each other is attracting attention as a solution for mounting the phased array antenna on the terminal. In order to minimize a shaded area and improve the beamforming coverage, a plurality of AiPs are required to be disposed in the terminal. In this case, a problem in that the mounting space becomes narrow may occur in consideration of electric coexistence thereof with other existing antennas and/or coexistence thereof with mechanical components. For example, since the mobile terminal includes various antennas such as a Wi-Fi antenna, a 3G or 4G antenna, and an GPS antenna in addition to a plurality of 5G antennas, and further includes components such as a camera and a battery, a scheme for efficiently mounting a plurality of AiPs in a limited space is required.

In the conventional millimeter wave AiP technology, a patch antenna is mainly used for broadside radiation. However, considering the coverage of the terminal, the patch antenna only supports a beam in one direction, which may cause a problem of occurrence of a shadow area. When the patch antenna is disposed at a side, an overall thickness (profile) may increase.

In addition, in the conventional millimeter wave AiP technology, in order to perform end-fire radiation, for example, a planar antenna, a Yagi-Uda antenna, or a cavity backed slot antenna is used. However, similarly, since the planar antenna, the Yagi-Uda antenna, or the cavity backed slot antenna only supports a beam in one direction, it may cause a problem of generating a shadow area.

In addition, in the technology of supporting a multi-directional beam for improving beam coverage, a pattern reconfigurable antenna via variation of an antenna mode using a plurality of antennas or an active element such as a PIN diode has been used. However, when the plurality of antennas are used, a space occupied by the plurality of antennas is increased, which is disadvantageous in terms of mounting the antenna device onto the terminal. When the active element is used, difficulty occurs in packaging thereof with an RFIC due to addition of a DC bias controller.

In order to solve the above-described problems, according to a radiator module for performing broadside radiation and end-fire radiation in accordance with one embodiment of the present disclosure, a radiator performing broadside radiation and a radiator performing end-fire radiation are positioned in a spatially-superposing manner, thereby minimizing structural complexity and achieving a miniaturized structure, thereby maximizing space efficiency and improving beamforming coverage.

In addition, according to an antenna device for performing broadside radiation and end-fire radiation according to another embodiment of the present disclosure, the antenna device includes a plurality of radiator modules, each radiator module being composed of a radiator performing broadside radiation and a radiator performing end-fire radiation positioned in a spatially-superposing manner, such that the antenna device is capable of individually performing beamforming in a broadside direction and beamforming in an end-fire direction.

More specifically, the broadside antenna and the end-fire antenna of the present disclosure are implemented to have a structure in which they share the same open surface within the same cavity, and thus the antenna device can be entirely mounted on a mobile device in a miniaturized structure while minimizing structural complexity. Therefore, the efficiency of space can be maximized, and two separate beams can be controlled independently such that the beamforming coverage can also be improved.

In addition, since the antenna of the present disclosure may be implemented as a single AiP in which RF integrated circuits respectively required for single-directional antennas, such as an existing broadside antenna and an existing end-fire antenna, are integrated with each other, the number of AiPs required in the terminal may be reduced. This is also advantageous in terms of cost efficiency.

Using the concept that different antennas share the same space with each other, the scheme of the present disclosure may be an optimal solution for mounting the antenna into the next-generation millimeter wave mobile device.

### Radiator Module

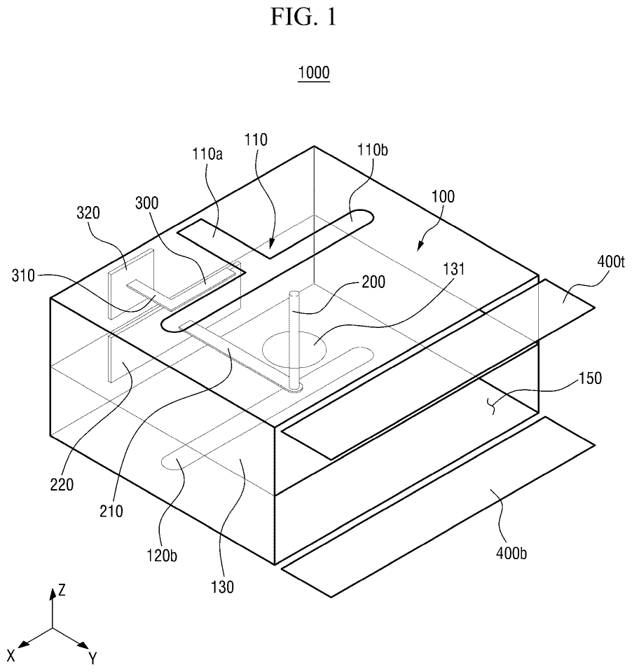

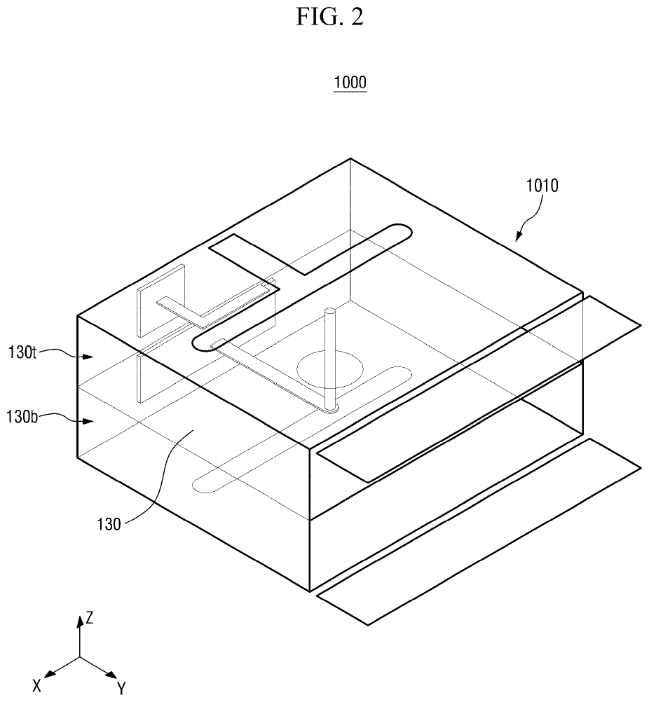

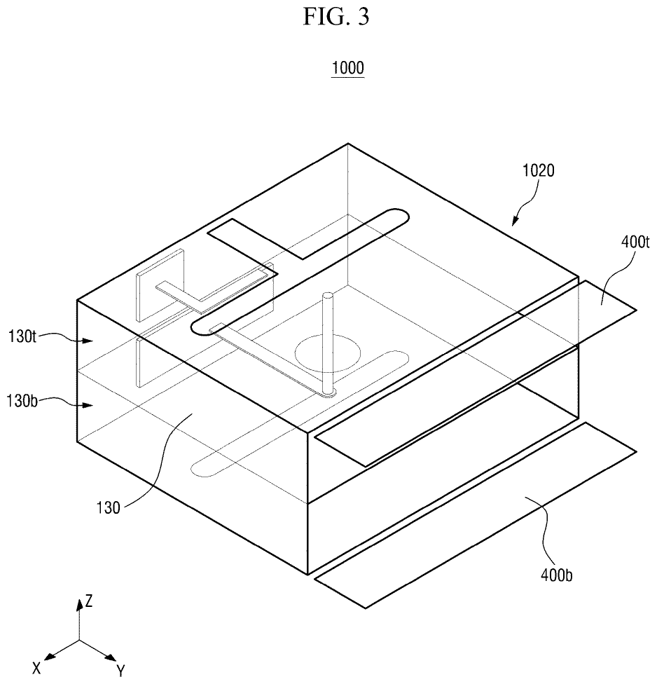

FIG. 1 is a perspective view of a radiator module performing broadside radiation and end-fire radiation according to an embodiment of the present disclosure, FIG. 2 shows a broadside radiation part of the radiator module of FIG. 1, and FIG. 3 shows an end-fire radiation part of the radiator module of FIG. 1. Hereinafter, a radiator module for performing broadside radiation and end-fire radiation according to an embodiment of the present disclosure will be described in more detail with reference to FIGS. 1 to 3.

Hereinafter, as used herein, the frontward direction of the radiator module may represent the +y-axis direction, the rearward direction of the radiator module may represent the −y-axis direction, and the ±y-axis direction may be referred to as a ‘lengthwise direction’. In addition, the left direction around the radiator module may represent the −x-axis direction, the right direction around the radiator module may represent the +x-axis direction, and the ±x-axis direction may also be referred to as a “width wise direction”. The upward direction around the radiator module may represent the +z-axis direction, the downward direction around the radiator module may represent the −z-axis direction, and the ±z-axis direction may be referred to as a “height direction”.

As illustrated in FIG. 1, a radiator module 1000 for performing broadside radiation and end-fire radiation according to an embodiment of the present disclosure may include a cavity 100, a widthwise feed line 300, and a vertical probe 200.

The cavity 100 may have an open surface 150 defined as a front surface thereof. As illustratively shown in FIG. 1, the open surface 150 may be formed as an entire front surface of the cavity 100, or may be formed as a portion of the front surface of the cavity 100. An RF signal may be transmitted and received through the open surface 150.

Further, an upper slot 110 may be disposed at an upper surface of the cavity 100. An RF signal may be transmitted and received through the upper slot 110. As shown in FIG. 1, according to one aspect of the present disclosure, the upper slot 110 may be, for example, a T-shaped slot including a lengthwise upper slot 110a and a widthwise upper slot 110b. However, the present disclosure is not limited thereto.

Components for transmitting and receiving the RF signal may be disposed inside the cavity 100.

For example, a widthwise feed line 300 may be disposed under the upper slot 110 and may extend in the left-right direction of the cavity. According to one aspect, the widthwise feed line 300 may receive the power from a second port 320 via a second feed line 310. Thus, the widthwise feed line 300 may be configured to be electrically connected to the upper slot 110 to perform broadside radiation. That is, the widthwise feeding line 300 may be configured to transmit and receive a signal upwardly of the radiator module. For example, the widthwise feed line 300 may serve as a component for feeding the power and may be electrically coupled with the upper slot 110, such that the upper slot 110 performs the broadside radiation.

Further, the vertical probe 200 extending in the vertical direction and inside the cavity 100 may be disposed inside the cavity 100. According to one aspect, the vertical probe 200 may receive the power from a first port 220 via a first feed line 210. Thus, the vertical probe 200 may be configured to perform end-fire radiation through the open surface 150 of the cavity 100. That is, the vertical probe 200 may be configured to transmit and receive a signal in the frontward direction of the radiator module. For example, the vertical probe 200 may act as a radiator for directly performing the end-fire radiation based on the power received from the feed line.

As illustrated in FIGS. 1 and 2, according to one aspect of the present disclosure, an inner space of the cavity 100 may be divided into an upper space 130t and a lower space 130b based on a dividing surface 130. As shown in FIGS. 1 to 3, the dividing surface 130 may include a through hole 131 through which the vertical probe 200 passes. Thus, the vertical probe 200 may be located in both the upper space 130t and the lower space 130b of the cavity 100.

As shown in FIG. 2, the radiator module 1000 according to one aspect of the present disclosure may be configured to perform broadside radiation using the upper space 130t. That is, for example, the widthwise feed line 300 disposed in the upper space 130t may be electrically connected to the upper slot 110 to perform the broadside radiation. Thus, the upper space 130t as indicated using a hatching in FIG. 2 may operate as a broadside antenna.

As illustrated in FIG. 3, the radiator module 1000 according to one aspect of the present disclosure may be configured to perform end-fire radiation using an entire area of the radiator module 1000. That is, for example, end-fire radiation may be performed through the open surface 150 based on the vertical probe 200 at least partially disposed in each of the upper space 130t and the lower space 130b. Thus, the entire area of the radiator module 1000 including the upper space 130t and the lower space 130b as indicated using a hatching in FIG. 3 may operate as an end-fire antenna.

As described with reference to FIGS. 2 to 3, the radiator module 1000 according to one aspect of the present disclosure may be configured to include both a broadside antenna and an end-fire antenna in the same space such that the broadside antenna and the end-fire antenna share a common open surface with each other. Therefore, an efficient mounting space may be achieved.

Further, according to one aspect of the present disclosure, for example, via selective signal transmission to the first port or the second port, the radiator module may operate as a broadside antenna or as an end-fire antenna. The broadside antenna and the end-fire antenna are disposed in the same space so that the radiation mode may be selected to vary as needed. Furthermore, in the case of implementing an array of a plurality of radiator modules, it is possible to independently control beams in the broadside direction and the end-fire direction, such that the beam coverage in the two directions may be secured.

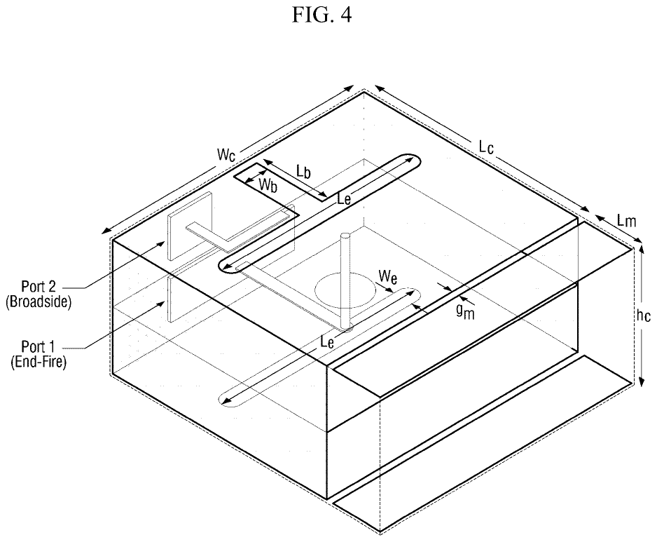

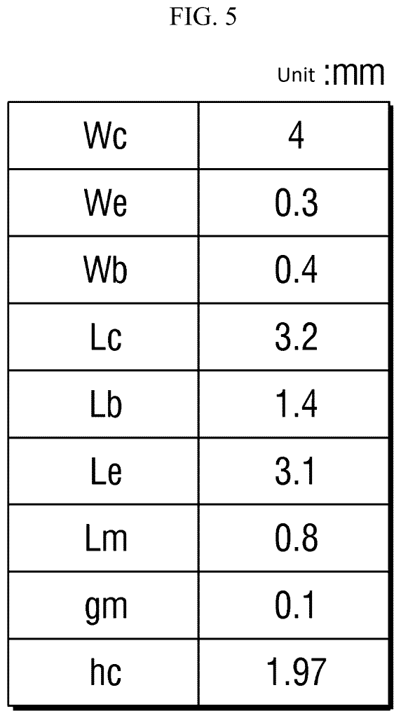

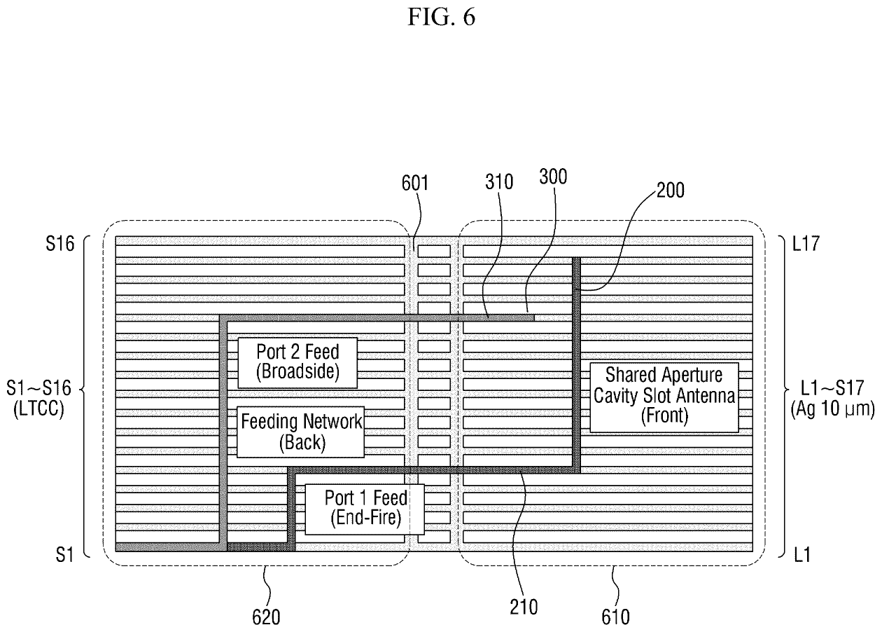

FIG. 4 is an example view of a radiator module implemented via a stacking scheme, and FIG. 5 shows an example numerical design of the radiator module of FIG. 4. FIG. 6 is a side view of an example radiator module implemented via a stacking scheme.

For example, as illustrated in FIG. 4, the radiator module for performing the broadside radiation and the end-fire radiation according to an embodiment of the present disclosure may be implemented using a two-dimensional stacking technology. However, the present disclosure is not limited thereto. According to one aspect, it is possible to manufacture the radiator module using selected ones of various processes and materials such as PCB, LTCC, and Glass. For example, the overall size thereof may be implemented as 0.37×0.38×0.18π (based on 28 GHz). However, the present disclosure is not limited thereto.

As shown in FIG. 4, the radiator module according to one aspect may include two ports, wherein Port1 may be composed of a strip line and a vertical probe and be used as an end-fire antenna power supply, and Port2 may be composed of a strip line having a ‘L’ shape and be used as a broadband antenna power supply. An example numerical design of the radiator module according to one aspect is shown in FIG. 5. However, it should be noted that this is only an example, and the design of the radiator module of the present disclosure is not limited thereto.

As shown in FIG. 6, a radiator module for performing broadside radiation and end-fire radiation according to one aspect of the present disclosure may be implemented based on, for example, a LTCC process. The example radiator module shown in FIG. 6 may be composed of 17 metal layers L1 to L17 and 16 dielectric layers S1 to S16.

The antenna may be positioned at a front surface 610 of the radiator module, and the feed line to each antenna may be positioned at a rear surface 620 via a vertical transition. As illustrated in FIG. 6, the front portion 610 may be provided with the vertical probe 200 receiving the power via the first feed line 210, and may be provided with the widthwise feed line 300 receiving the power via the second feed line 310. In the side view of FIG. 6, regarding the widthwise feed line 300, only a distal contact end of the second feed line 310 is shown.

The end-fire antenna may be located across all layers L1 to L17, and the broadside antenna may be located only across the upper layers L9 to L17. The outer wall of the antenna may be composed of vias 601 made of metal.

Based on a result of checking the electric field distribution around the radiator module implemented according to one aspect, in the radiating area of the cavity including the upper and lower slots and the open distal end of the front portion, the distribution of a strong electric field in the vertical direction (θ) was identified resulting in the identification of vertical polarization. In the radiating area of the upper slot, the distribution of a strong electric field in the horizontal direction (Φ) was identified resulting in the identification of horizontal polarization.

Furthermore, based on a result of checking the impedance characteristics of the designed structure, it was identified that the reflection coefficient of the end-fire antenna was −10 dB or lower at 27.51 to 30.62 GHz, and the reflection coefficient of the broadside antenna was −10 dB or lower at 27.59 to 28 GHz. The mutual coupling coefficient between the two ports was maintained at a value below −32 dB in the operating band. The gain of the end-fire antenna was 4.16 dBi, and the gain of the broadside antenna was 3.23 dBi.

However, it should be noted that the stack type radiator module as described through FIGS. 4 to 6 is merely according to an embodiment, and the technical idea of the present disclosure is not limited thereto.

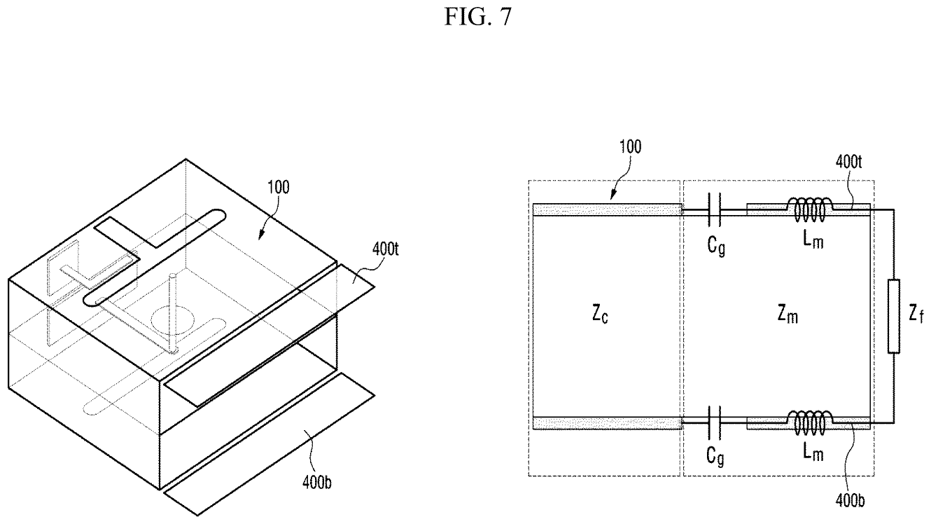

FIG. 7 illustrates a metal layer pair of a radiator module according to one aspect. As shown in FIGS. 1 and 7, the radiator module 1000 for performing broadside radiation and end-fire radiation according to an embodiment of the present disclosure may include a metal layer pair including an upper metal layer 400t disposed in front of an upper surface of the cavity 100 and a lower metal layer 400b disposed in front of a lower surface of the cavity 100 and extending in parallel with the upper metal layer.

It is possible to match the impedance between the free space and the cavity and to improve the bandwidth and gain via adjustment of the parallel upper and lower metal layers respectively located in front of the end-fire antenna. That is, impedance matching between the radiator module 1000 and the free space may be performed based on the spacing between the metal layer pair 400t and 400b and the cavity 100 and the length in the front-rear direction of the metal layer pair 400t and 400b.

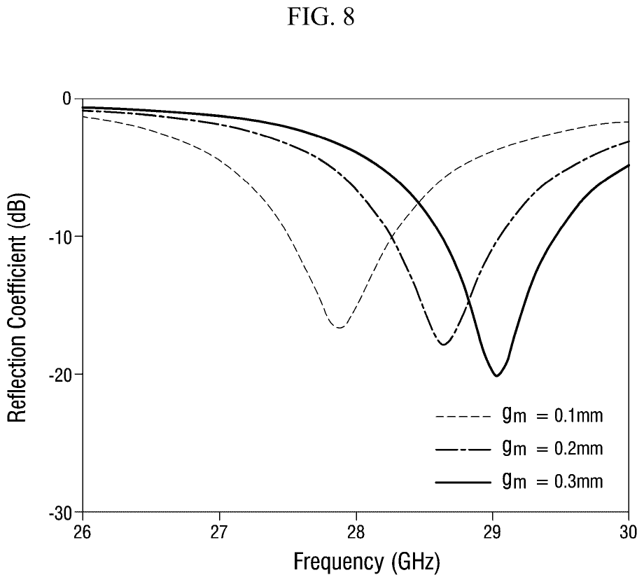

More specifically, a series capacitance component C_{g} can be induced based on a spacing Gₘ between the metal layer pair 400t and 400b and the cavity 100. FIG. 8 illustrates impedance matching based on a spacing between the metal layer pair of FIG. 7 and the cavity. The band of the impedance matching may be determined by adjusting the spacing Gₘ between the metal layer pair 400t and 400b and the cavity 100 as shown in FIG. 8.

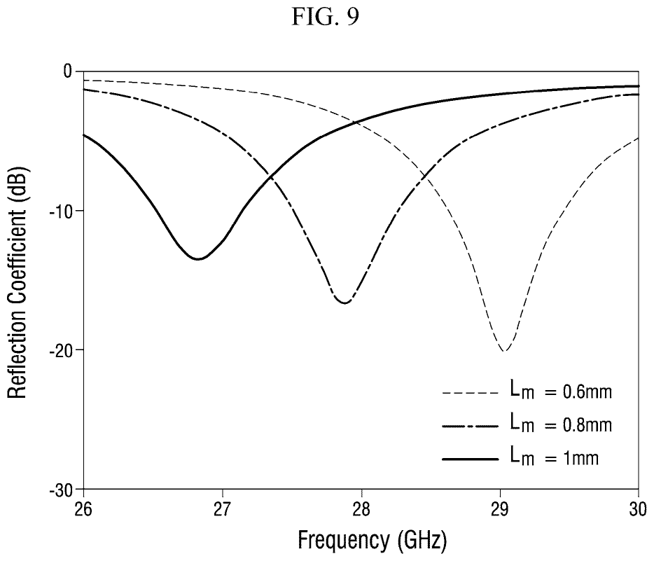

In addition, an inductance component Lₘ can be induced based on the length Lₘ in the front-rear direction of the metal layer pair 400t and 400b. FIG. 9 illustrates impedance matching based on the length of the metal layer pair of FIG. 7. As shown in FIG. 9, the band of the impedance matching may be determined by adjusting the length Lₘ in the front-rear direction of the metal layer pair 400t and 400b.

Further, according to one aspect, the upper slot 110 of the radiator module 1000 according to an embodiment of the present disclosure may include a width wise upper slot 110b extending in the left-right direction of the cavity and a lengthwise upper slot 110a extending in the front-rear direction of the cavity. For example, as shown in FIG. 1, the upper slot 110 may be ‘T’ shaped so as to include the widthwise upper slot 110b and the lengthwise upper slot 110a. In addition, according to one aspect, as shown in FIG. 1, a widthwise lower slot 120b extending parallel to the widthwise upper slot 110b may be provided at the lower surface of the cavity 100 such that the widthwise upper slot and the widthwise lower slot 120b constitute a slot pair.

The bandwidth and the front-to-back ratio of the end-fire antenna can be improved using the slot pair of the widthwise upper slot 110b and the widthwise lower slot 120b parallel to each other. In addition, the bandwidth can be improved via generation of a new electric field via the slot pair 110b and 120b.

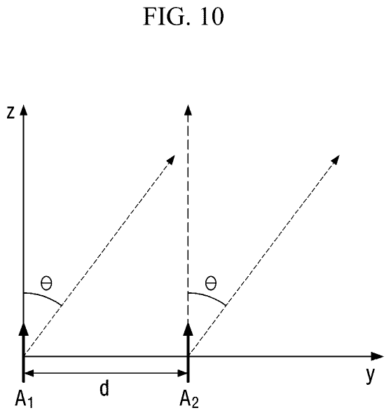

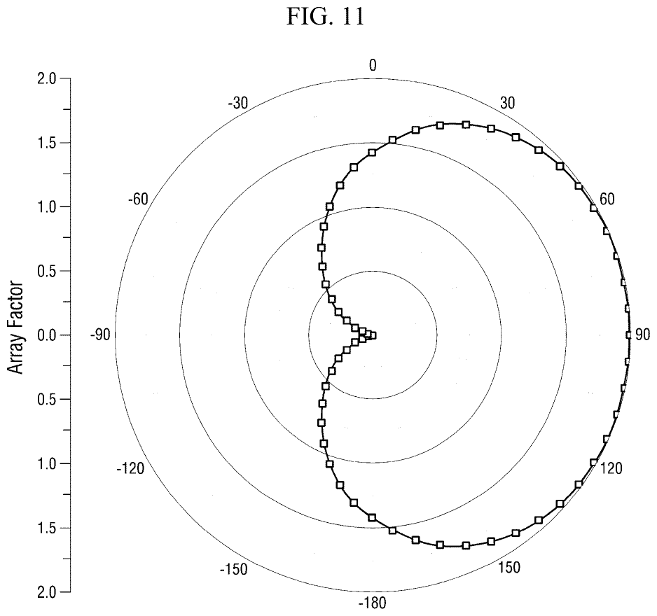

In this regard, FIG. 10 is an example view of the improvement of the front-to-rear ratio based on the distance between the slot pair and the open surface of the radiator module according to one aspect, and FIG. 11 illustrates a radiation aspect according to the arrangement of FIG. 10.

As shown in FIG. 10, when the radiation component by the pair of the parallel upper and lower slots and the radiation component by the open surface 150 of the cavity 100 are expressed as A1 and A2, respectively, this configuration is considered as a 1×2 array antenna. In this regard, when a distance d between the slot pair 110b and 120b and the open surface is π/4 and the phase difference between the two antennas is −90 degrees, a null is generated in the rearward radiation and the frontward radiation is maximized, based on the array factor equation so that the front-to-back ratio may be improved. That is, according to one aspect, in the radiator module, the distance between the slot pair 110b and 120b and the open surface 150 may be π/4.

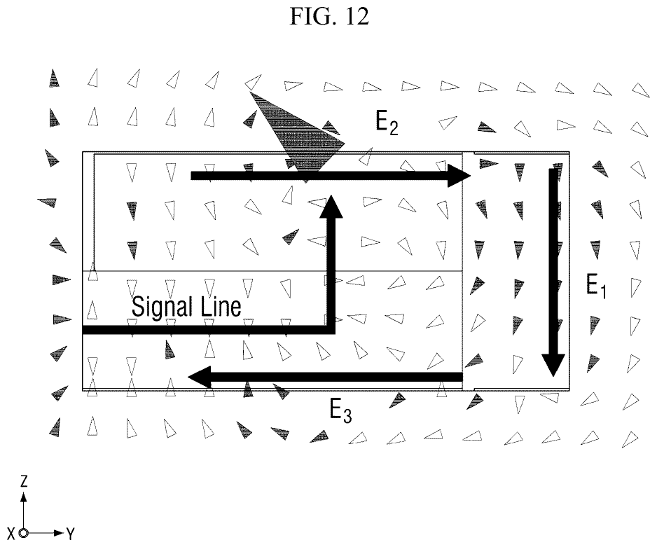

FIG. 12 shows an example in which electric fields generated from upper and lower slots offset each other according to one aspect. In the radiator module 1000 according to an embodiment of the present disclosure, the electric field generated from the widthwise upper slot 110b and the electric field generated from the widthwise lower slot 120b may have the same magnitude and the phases opposite to each other and thus may offset each other. For example, as shown in FIG. 12, the electric field E2 generated from the upper slot 110b and the magnitude of the electric field E3 generated from the lower slot 120b have the same magnitude and the phases opposite to each other and thus offset each other, such that only the electric field E1 in the frontward radiation remains, and thus the front-to-back ratio may be improved.

Further, in the radiator module 1000 according to one aspect of the present disclosure, the broadside antenna may operate as a cavity backed slot antenna performing broadside radiation based on the upper slot extending in the y-axis direction, that is, the lengthwise upper slot 110a. In this regard, the width of the lengthwise upper slot 110a may determine impedance matching and the length thereof may determine a frequency band. That is, the impedance matching may be performed based on the width of the lengthwise upper slot, and the frequency band may be determined based on the length of the lengthwise upper slot.

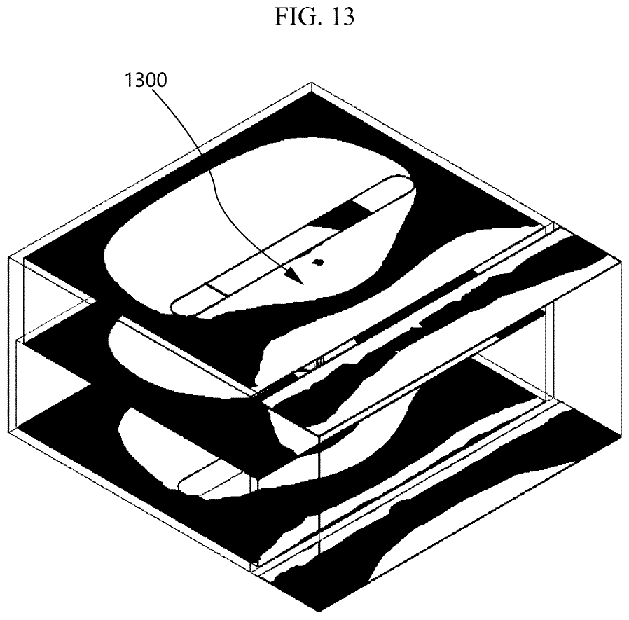

FIG. 13 illustrates a strong coupling phenomenon between a vertical probe and a widthwise upper slot. As illustrated in FIG. 13, when the upper slot has only the widthwise slot and is free of the lengthwise slot, the upper slot has the same polarization component as that of the vertical end-fire feeding portion, and thus extreme mutual coupling between the two ports may occur. That is, a strong coupling phenomenon may occur between the vertical probe and the widthwise upper slot. In FIG. 13, a strong coupling 1300 between the upper slot and the vertical probe when the upper slot has only the widthwise upper slot is identified.

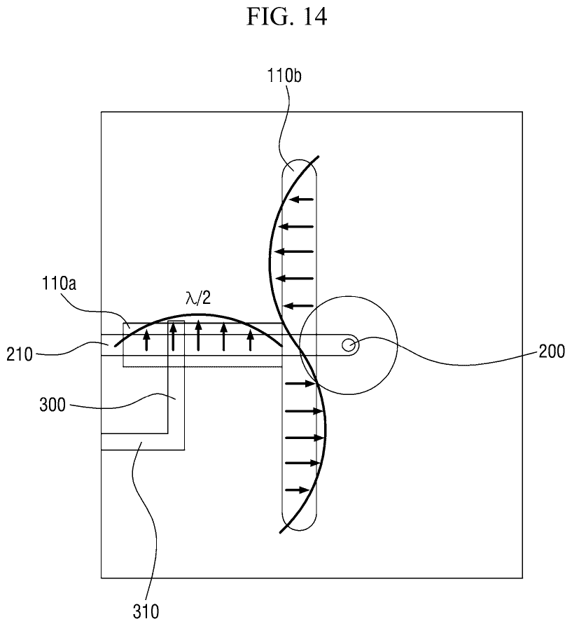

FIG. 14 illustrates an example of an improvement in coupling between ports based on an arrangement of the widthwise slot and the lengthwise slot. As shown in FIGS. 1 and 14, the upper slot 110 is constructed in a ‘T’ shape so as to have the lengthwise upper slot 110a and the widthwise upper slot 110b, and the broadside feeding portion is implemented as a strip line in a ‘L’ shape, thereby improving mutual coupling between the two ports. As shown in FIG. 14, it may be identified that a null occurs in the end-fire feeding portion.

More specifically, the lengthwise upper slot 110a is designed to have a length of π/2 and the widthwise upper slot 110b is designed to have a length of π, such that a strong electric field is generated in the lengthwise upper slot 110a and a null is generated in a center of the widthwise upper slot 110b when the broadside antenna is fed with the power, thereby improving mutual coupling. In this regard, the lengthwise upper slot and the widthwise upper slot may be configured to be in contact with each other at a midpoint of the widthwise upper slot. In addition, according to one aspect, the vertical probe 200 may be disposed in front of the widthwise upper slot 110b. Therefore, it is possible to minimize the coupling phenomenon between the broadside radiation component and the vertical probe 200.

### Antenna Device

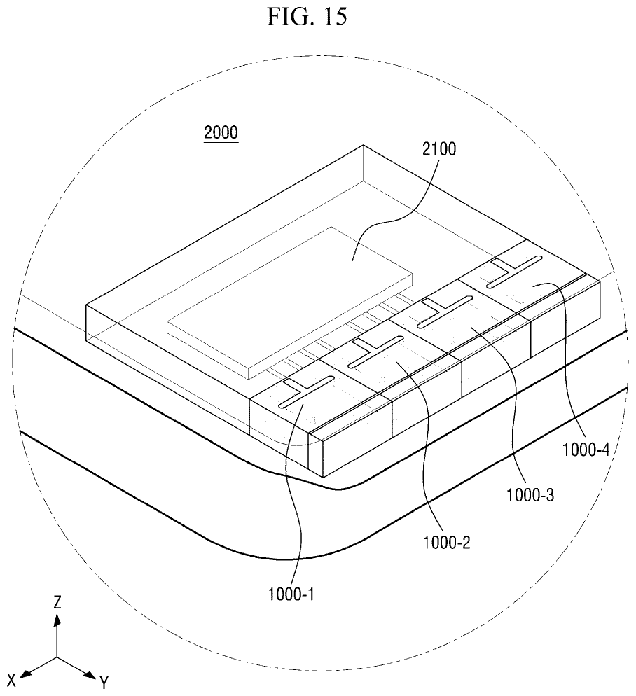

FIG. 15 is an example application diagram in which an antenna device according to an embodiment of the present disclosure is applied to a wireless terminal. As illustrated in FIG. 15, an antenna device 2000 according to an embodiment of the present disclosure includes a radiator array including a plurality of radiator modules 1000-1, 1000-2, 1000-3, and 1000-4, and a control circuit 2100 configured to apply a signal to the plurality of radiator modules. In this regard, for example, the control circuit 2100 may be RFIC. However, the present disclosure is not limited thereto.

Each of the plurality of radiator modules may include a cavity having a front open surface and an upper slot disposed at an upper surface thereof, a widthwise feeding line disposed under the upper slot and extending in the left-right direction of the cavity, and a vertical probe extending in the vertical direction and inside the cavity. For example, the radiator modules for performing broadside radiation and end-fire radiation according to an embodiment of the present disclosure may constitute the radiator array.

In this regard, the control circuit 2100 may control each of the plurality of radiator modules to perform broadside radiation to perform broadside beamforming, and may control each of the plurality of radiator modules to perform end-fire radiation to perform end-fire beamforming.

Accordingly, the number of AiPs supporting the general unidirectional direction may be reduced, and at the same time, beamforming coverage may be improved. In addition, since the antenna device can be implemented in a small size, it is advantageous for the installation thereof into the current mobile device. All parts of the antenna structure except for the slot may be made of metal. This is advantageous for packaging the same with an RF integrated circuit and performing SMT the same on other components.

In an example, the radiator module had a total of two ports and a 1×4 phased array structure including the radiator modules was manufactured using the LTCC process. The beam steering performance thereof was verified. Based on a result of measuring the impedance of the end-fire antenna and the broadside antenna, a matching correlation between simulation and measurement was identified. Based on the radiation pattern measurement result of a single antenna, a matching correlation between simulation and measurement was identified. Based on a result of measuring the radiation pattern of the 1×4 array antenna, a matching correlation between simulation and measurement was identified, and the gain of the end-fire antenna was 9.56 dBi and the gain of the broadside antenna was 8.9 dBi.

In addition, based on a result of the radiation pattern measurement of the 1×4 array antenna, a matching correlation between simulation and measurement was identified, and the 3 dB beam steering angle of each of the two antennas was ±45 degrees in each direction. In addition, it was also identified that in a total scan pattern, beam steering can be independently performed in each of the end-fire antenna and the broadside antenna, thereby improving beamforming coverage.

Although the present disclosure has been described above with reference to the drawings and embodiments, it will be understood that the scope of the present disclosure is not limited by the drawings or the embodiments, and those skilled in the art can variously modify and change the present disclosure within the scope not departing from the spirit and field of the present disclosure as described in the following claims.

The present disclosure as described above is described based on a series of functional blocks, but is not limited to the above-described embodiments and the accompanying drawings, and it will be apparent to those skilled in the art to which the present disclosure belongs that various substitutions, modifications, and changes may be made thereto within the scope not departing from the technical spirit of the present disclosure.

The present disclosure is not limited to the above-described embodiments, and various types of combinations of the above-described embodiments as well as the above-described embodiments may be provided according to implementation and/or necessity.

In the above-described embodiments, the methods are described based on a flowchart as a series of steps or blocks, but the present disclosure is not limited to the order of the steps, and some steps may occur in a different order from that disclosed herein or simultaneously with the above-described steps. In addition, those of ordinary skill in the art will appreciate that the steps shown in the flowchart are not exclusive, other steps may be included, or one or more steps in the flowchart may be deleted without affecting the scope of the present disclosure.

The foregoing embodiment includes examples of various aspects. While it is not possible to describe all possible combinations for representing various aspects, those of ordinary skill in the art will be able to recognize that other combinations are possible. Accordingly, the present disclosure may include all other replacements, modifications, and changes that fall within the scope of the following claims.

### REFERENCE NUMERALS

100: Cavity
110: Upper slot
110a: Lengthwise upper slot
110b: Widthwise upper slot
120b: Widthwise lower slot
130: Dividing surface
200: Vertical probe
300: Widthwise feed line

1. A radiator module for performing broadside radiation and end-fire radiation, the radiator module comprising:
a cavity having a front open surface and an upper slot defined in an upper surface thereof;
a widthwise feed line disposed under the upper slot and extending in a left-right direction of the cavity; and
a vertical probe extending in a vertical direction and disposed inside the cavity.

2. The radiator module for performing broadside radiation and end-fire radiation of claim 1, wherein the vertical probe receives electrical power from a first port via a first feed line, and
wherein the widthwise feed line receives electrical power from a second port via a second feed line.

3. The radiator module for performing broadside radiation and end-fire radiation of claim 1, wherein the widthwise feed line is electrically connected to the upper slot to perform broadside radiation.

4. The radiator module for performing broadside radiation and end-fire radiation of claim 1, wherein the vertical probe is configured to perform the end-fire radiation through the front open surface.

5. The radiator module for performing broadside radiation and end-fire radiation of claim 1, wherein the cavity is divided into an upper space and a lower space around a dividing surface, and
wherein the radiator module is configured to perform the broadside radiation using the upper space, and perform the end-fire radiation using both the upper space and the lower space.

6. The radiator module for performing broadside radiation and end-fire radiation of claim 5, wherein the dividing surface has a through hole defined therein through which the vertical probe passes.

7. The radiator module for performing broadside radiation and end-fire radiation of claim 1, wherein the radiator module further comprises a metal layer pair, wherein the metal layer pair includes:
an upper metal layer disposed in front of the upper surface of the cavity; and
a lower metal layer disposed in front of a lower surface of the cavity and extending in parallel with the upper metal layer.

8. The radiator module for performing broadside radiation and end-fire radiation of claim 7, wherein impedance matching between the radiator module and a free space is performed based on a spacing between the metal layer pair and the cavity and a length in a front-rear direction of the metal layer pair.

9. The radiator module for performing broadside radiation and end-fire radiation of claim 8, wherein a series capacitance component is induced based on a spacing between the metal layer pair and the cavity, and
wherein an inductance component is induced based on the length in the front-rear direction of the metal layer pair.

10. The radiator module for performing broadside radiation and end-fire radiation of claim 1, wherein the upper slot includes:
a widthwise upper slot extending in the left-right direction of the cavity; and
a lengthwise upper slot extending in a front-rear direction of the cavity.

11. The radiator module for performing broadside radiation and end-fire radiation of claim 10, wherein the radiator module further comprises a widthwise lower slot defined in a lower surface of the cavity and extending in parallel with the widthwise upper slot such that the widthwise upper and lower slots constitute a slot pair.

12. The radiator module for performing broadside radiation and end-fire radiation of claim 11, wherein a spacing between the slot pair and the front open surface is π/4.

13. The radiator module for performing broadside radiation and end-fire radiation of claim 11, wherein an electric field generated from the widthwise upper slot and an electric field generated from the widthwise lower slot have the same magnitude and different phases opposite to each other and thus offset each other.

14. The radiator module for performing broadside radiation and end-fire radiation of claim 10, wherein the radiator module operates as a cavity backed slot antenna performing the broadside radiation based on the lengthwise upper slot.

15. The radiator module for performing broadside radiation and end-fire radiation of claim 10, wherein impedance matching is performed based on a width of the lengthwise upper slot, and
wherein a frequency band is determined based on a length of the lengthwise upper slot.

16. The radiator module for performing broadside radiation and end-fire radiation of claim 10, wherein the lengthwise upper slot has a length of π/2,
wherein the widthwise upper slot has a length of π, and
wherein the lengthwise upper slot and the widthwise upper slot are configured to be in contact with each other at a midpoint of the widthwise upper slot.

17. The radiator module for performing broadside radiation and end-fire radiation of claim 16, wherein the vertical probe is disposed in front of the widthwise upper slot.

18. An antenna device for performing broadside radiation and end-fire radiation, the antenna device comprising:
a radiator array including a plurality of radiator modules; and
a control circuit configured to apply a signal to the plurality of radiator modules,
wherein each of the plurality of radiator modules includes:
a cavity having a front open surface and an upper slot defined in an upper surface thereof;
a widthwise feed line disposed under the upper slot and extending in a left-right direction of the cavity; and
a vertical probe extending in a vertical direction and disposed inside the cavity.

19. The antenna device for performing broadside radiation and end-fire radiation of claim 18, wherein the control circuit is configured to control each of the plurality of radiator modules to perform broadside radiation to perform broadside directional beamforming.

20. The antenna device for performing broadside radiation and end-fire radiation of claim 18, wherein the control circuit is configured to control each of the plurality of radiator modules to perform end-fire radiation to perform end-fire directional beamforming.
